(19) United States
(12) Patent Application Publication
(10) Pub. No.: US 2024/0015184 A1
(43) Pub. Date: Jan. 11, 2024

(54) METHOD OF APPLYING SECURITY POLICIES TO VIRTUAL COMPUTING INSTANCES

(71) Applicant: VMWARE, INC., Palo Alto, CA (US)

(72) Inventors: SHIRISH VIJAYVARGIYA, Pune (IN); NAKUL OGALE, Pune (IN); SUNIL HASBE, Pune (IN); ROSHAN KOLHE, Wardha (IN)

(21) Appl. No.: 17/903,035

(22) Filed: Sep. 5, 2022

(30) Foreign Application Priority Data
Jul. 7, 2022 (IN) 202241039184

(51) Int. Cl. H04L 9/40; G06F 9/455

(52) U.S. Cl. CPC H04L 63/20; G06F 9/45558; H04L 63/1433; G06F 2009/45587; G06F 2009/45595; G06F 2009/45562

(57) ABSTRACT

A method of applying a security policy to a virtual computing instance, according to an embodiment, includes: determining that a universally unique identifier (UUID) of the virtual computing instance does not match an identifier stored in a configuration file of the virtual computing instance; transmitting a request to register the virtual computing instance with a cloud platform for managing security policies of a virtual infrastructure that includes the virtual computing instance, the request including the UUID of the virtual computing instance and the identifier stored in the configuration file of the virtual computing instance; in response to the request, receiving an identifier of a security policy to be applied; and retrieving the security policy and applying the security policy to the virtual computing instance.

### Related Applications

Benefit is claimed under 35 U.S.C. 119(a)-(d) to Foreign Application Serial No. 202241039184 filed in India entitled “METHOD OF APPLYING SECURITY POLICIES TO VIRTUAL COMPUTING INSTANCES”, on Jul. 7, 2022, by VMware, Inc., which is herein incorporated in its entirety by reference for all purposes.

### Background

Software-defined data centers (SDDCs) have enabled auto-scaling of applications based on incoming load/traffic on the applications. In such a scenario, one or more virtual computing instances, such as virtual machines (VMs), are spawned to handle the extra load on an application. When the load on the application reduces, some of these virtual computing instances are terminated.

Virtual infrastructure management (VIM) software of the SDDCs employ cloning technology to spawn virtual computing instances on demand and in situations where security services for the virtual computing instances are provided from a cloud platform, such as VMware Carbon Black®, the latest updates to security policies are communicated to running virtual computing instances through security agents installed therein. However, the latest updates cannot be applied to auto-scaled virtual computing instances until they are up and running and some may have been terminated even before the latest updates have been applied.

### Summary

One or more embodiments provide a method of applying the latest security policy updates to running virtual computing instances as well as to virtual computing instances that are deployed as a result of auto-scaling. A method of applying a security policy to a virtual computing instance, according to an embodiment, includes: determining that a universally unique identifier (UUID) of the virtual computing instance does not match an identifier stored in a configuration file of the virtual computing instance; transmitting a request to register the virtual computing instance with a cloud platform for managing security policies of a virtual infrastructure that includes the virtual computing instance, the request including the UUID of the virtual computing instance and the identifier stored in the configuration file of the virtual computing instance; in response to the request, receiving an identifier of a security policy to be applied; and retrieving the security policy and applying the security policy to the virtual computing instance.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtual computing environment in which one or more embodiments may be implemented.

FIG. 2 is a flow diagram that illustrates a method of deploying virtual computing instances in the virtual computing environment of FIG. 1.

FIG. 3 is a flow diagram of a method of applying security policies to virtual computing instances, according to embodiments.

FIG. 4 is a flow diagram of a method of registering security agents installed in virtual computing instances, according to embodiments.

FIG. 5 is a flow diagram of a method of applying updated security policies to virtual computing instances, according to embodiments.

### DETAILED DESCRIPTION

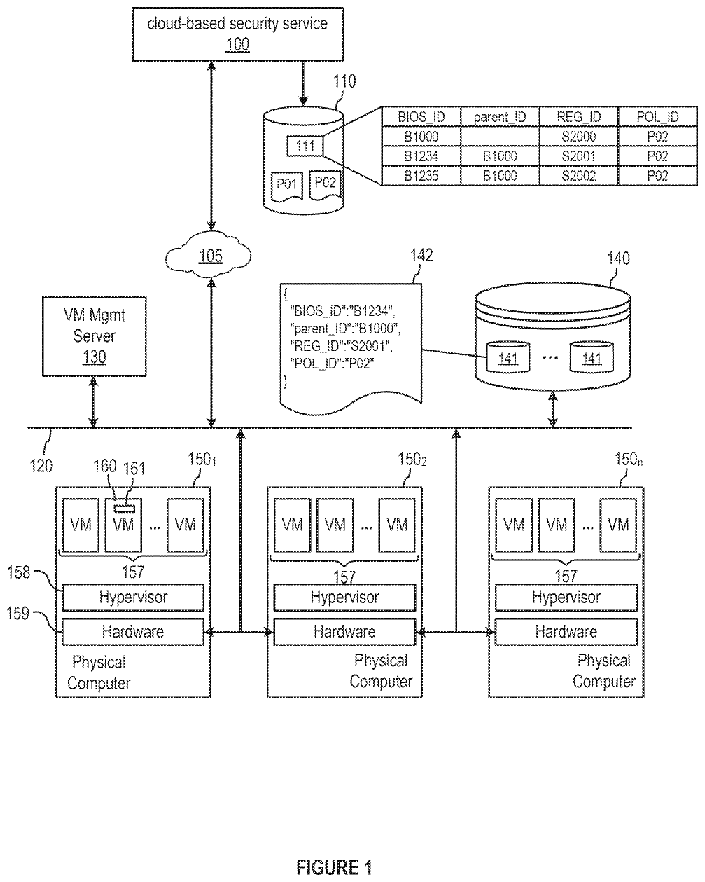

FIG. 1 is a block diagram of a virtual computing environment in which one or more embodiments may be implemented. In the embodiments illustrated herein, virtual computing instances deployed in the virtual computing environment are VMs, and the deployment of the VMs and the auto-scaling of the VMs are managed by a VM management server 130. In some embodiments, virtual computing instances deployed in the virtual computing environment are containers.

As illustrated in FIG. 1, VMs 157 are deployed on a plurality of physical computers 150₁, 150₂, . . . , 150ₙ, (also referred to as “host computers”), which VM management server 130 manages as a cluster to provide cluster-level functions, such as load balancing across the cluster through VM migration between the hosts, distributed power management, dynamic VM placement according to affinity and anti-affinity rules, and high availability (HA). VM management server 130 also manages a shared storage device 140 and provisions storage resources for the cluster (e.g., one or more virtual disks 141 for each of VMs 157) from shared storage device 140.

Each of the host computers includes a hypervisor 158 (more generally, “virtualization software”) and a hardware platform 159. Hardware platform 159 contains components of a conventional computer system, such as one or more central processing units, system memory in the form of dynamic and/or static random access memory, one or more network interface controllers connected to a network 120, and a host bus adapter connected to shared storage 140. In some embodiments, hardware platform 159 includes a local storage device, such as a hard disk drive or a solid state drive, and the local storage devices of the host computers are aggregated and provisioned as shared storage device 140.

In the embodiments, security service is provided to VMs 157 by a cloud-based security service 100 running in a container or a VM that has been deployed on a virtual infrastructure of a cloud computing system. Cloud-based security service 100 communicates with security agents installed in VMs 157 (e.g., security agent 161 installed in VM 160) over a public network 105, e.g., the Internet, to deliver security services to VMs 157.

Cloud-based security service 100 saves in a table 111 that is stored in a storage device 110, various information about the VMs in which its security agents are installed. Each entry in table 111 corresponds to one VM and includes a universally-unique identifier (UUID) of the VM (e.g., the ID given to the basic input/output system of the VM, referred to herein as “BIOS_ID”), a UUID of a parent VM from which the VM was cloned (e.g., the BIOS_ID of the parent VM, referred to herein as “parent_ID”), a registration ID assigned to the security agent installed in the VM during registration of the security agent with cloud-based security service 100 (referred to herein as “REG_ID”), and a policy ID of the security policy that the security agent installed in the VM was instructed to apply (referred to herein as “POL_ID”). The different security polices that are to be applied to the VMs are depicted in FIG. 1 as stored in storage device 110 as P01 and P02. Typically, the security policies are stored in a separate repository that is accessed by the security agents through public network 105.

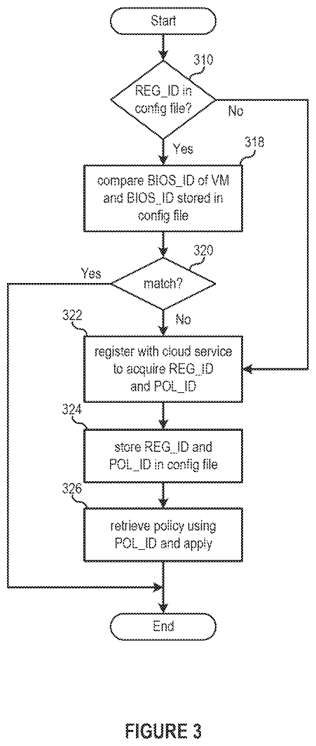

FIG. 1 also depicts a configuration file 142 that is saved in a virtual disk of each VM. Configuration file 142 of a VM contains the following information: BIOS_ID, parent_ID, REG_ID, and POL_ID. A VM that is not cloned from another VM is referred to herein as a “parent” VM or a “root” VM. The “parent_ID” field in configuration file 142 of such a VM is blank. When a VM is cloned from a root VM, a copy of configuration file 142 of the root VM is made and the contents of configuration file 142 are updated in accordance with the method depicted in FIG. 3.

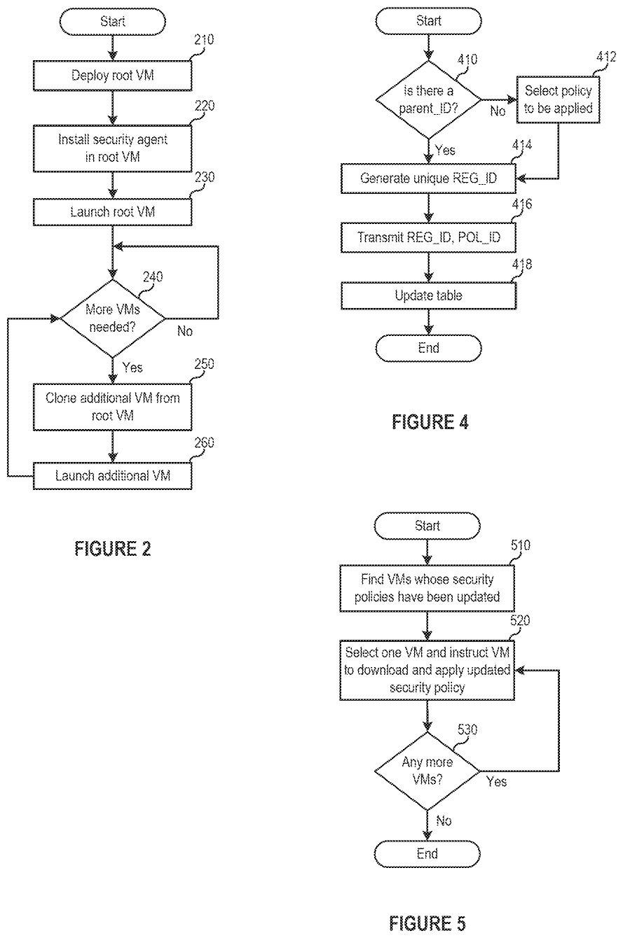

FIG. 2 is a flow diagram that illustrates a method of deploying VMs in the virtual computing environment of FIG. 1. In one example, the VMs are VMs of a virtual desktop infrastructure (VDI). The VMs each have a remote desktop running therein and are spawned and terminated as users of the remote desktops log into and out of their respective remote desktops. In another example, the VMs support a running application and are spawned and terminated according to the load on the running application.

The method of FIG. 2 is carried out by VM management server 130 and begins at step 210 with the deployment of a root VM. At step 220, a security agent of cloud-based security service 100 is installed in the root VM. Then, at step 230, the root VM is launched. Upon launch, the security agent of the root VM executes the method depicted in FIG. 3, the steps of which are described below.

After launching the root VM, VM management server 130 executes step 240 to determine if more VMs are needed to support the VDI or a running application. This determination is carried out by, for example, by an auto-scaling service running in VM management server 130. If so, VM management server 130 at step 250 clones an additional VM from the root VM, and at step 260 launches the additional VM. Upon launch of this additional VM, the security agent of this additional VM executes the method depicted in FIG. 3. The method then returns to step 240 to check again if more VMs are needed.

FIG. 3 is a flow diagram of a method of applying security policies to VMs, according to embodiments. As described above, this method is executed by a security agent installed in a VM upon launch of the VM. At step 310, the security agent accesses its configuration file, e.g., configuration file 142 shown in FIG. 1, to determine if a registration ID is present. For a root VM being launched for the first time, the “REG_ID” field is null (because it has not been populated yet) and so step 322 is executed next. At step 322, the security agent of the root VM registers with cloud-based security service 100 by sending a registration request along with its BIOS ID. In response, cloud-based security service 100 executes the method depicted in FIG. 4 to return a registration ID (REG_ID) and a policy ID (POL_ID), which the security agent of the root VM stores in its configuration file at step 324. At step 324, the security agent of the root VM retrieves the security policy associated with the policy ID from storage device 110 (or the repository for security polices of cloud-based security service 100) and applies them to the root VM. The method ends thereafter.

When the root VM is launched for the second time and thereafter, the “REG_ID” field will have been populated at step 314 and step 318 is executed next. Similarly, for VMs cloned from the root VM, the “REG_ID” field will contain the registration ID of the root VM and so step 318 is executed next. At step 318, the security agent of the VM (which may be either the root VM or a cloned VM) compares the BIOS ID of the VM with the BIOS_ID stored in its configuration file and determines at step 320 if there is a match. For a root VM, the two will match. For a cloned VM launched for the first time, there will be a mismatch because the BIOS ID of the root VM is stored in the configuration file. For a cloned VM launched for the second time and thereafter, the two will match because the BIOS ID of the cloned VM will have been stored in the configuration file at step 324.

If the security agent determines there is a match at step 320, the method ends. On the other hand, if the security agent determines there is no match at step 320, the security agent executes step 322 to register with cloud-based security service 100. When the security agent of a cloned VM executes step 322, it sends a registration request along with its BIOS ID and the BIOS ID of the root VM (which was retrieved from the “BIOS_ID” field of the configuration file and used in the comparison at step 318). In response, cloud-based security service 100 executes the method depicted in FIG. 4 to return a registration ID (REG_ID) and a policy ID (POL_ID), which the security agent of the cloned VM stores in its configuration file at step 324. At step 324, the security agent of the cloned VM retrieves the security policy associated with the policy ID from storage device 110 (or the repository for security polices of cloud-based security service 100) and applies them to the cloned VM. The method ends thereafter.

FIG. 4 is a flow diagram of a method of registering security agents installed in VMs, according to embodiments. The method of FIG. 4 is carried out by cloud-based security service 100 upon receipt of a registration request from a security agent. At step 410, cloud-based security service 100 determines if a parent_ID is included in the registration request. As described above, a registration request from a root VM does not contain a parent_ID, whereas a registration request from a cloned VM does contain a parent_ID. In the embodiments, cloned VMs share the security policy of the root VM and therefore step 412 of selecting a security policy to apply is executed only for the root VM. Thus, if cloud-based security service 100 determines at step 410 that the registration request does not contain a parent_ID, it selects a security policy to be applied at step 412. If not, step 412 is skipped and step 414 is executed next.

At step 414, cloud-based security service 100 generates a registration ID for the security agent that is requesting registration. Then, at step 416, cloud-based security service 100 transmits the registration ID (REG_ID) and the policy ID (POL_ID) to the security agent. The registration ID that is sent is the one generated at step 414. The policy ID that is sent to the security agent of the root VM is that of the policy selected at step 412. The policy ID that is sent to the security agent of a cloned VM is that of the policy selected for its root VM, and is obtained by performing a look-up of table 111 using parent_ID that was sent in the registration request. At step 418, cloud-based security service 100 updates table 111 to add a new entry corresponding to the security agent that is requesting registration and to populate each of the corresponding fields. It should be noted that the parent_ID field for the security agent of the root VM is null whereas the parent_ID field for each of the security agents of the cloned VMs is populated with the BIOS ID of the root VM.

FIG. 5 is a flow diagram of a method of applying updated security policies to VMs, according to embodiments. The method of FIG. 5 is triggered, for example, by an update made to a security policy in response to newly discovered security vulnerabilities. At step 510, cloud-based security service 100 determines which VMs need the security policy update. It finds these VMs by performing a look-up of table 111 for VMs to which the security policy that has been updated has been applied. Then, cloud-based security service 100 loops through steps 520 and 530 for each such VM to instruct each such VM to download and apply the updated security policy.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, NAS, read-only memory (ROM), RAM (e.g., flash memory device), Compact Disk (e.g., CD-ROM, CD-R, or CD-RW), Digital Versatile Disk (DVD), magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, modifications, additions, and improvements may fall within the scope of the appended claims.

What is claimed is:

1. A method of applying a security policy to a virtual computing instance, said method comprising:
determining that a universally unique identifier (UUID) of the virtual computing instance does not match an identifier stored in a configuration file of the virtual computing instance;
transmitting a request to register the virtual computing instance with a cloud platform for managing security policies of a virtual infrastructure that includes the virtual computing instance, the request including the UUID of the virtual computing instance and the identifier stored in the configuration file of the virtual computing instance;
in response to the request, receiving an identifier of a security policy to be applied; and
retrieving the security policy and applying the security policy to the virtual computing instance.

2. The method of claim 1, wherein the identifier stored in a configuration file of the virtual computing instance is a UUID of a root virtual computing instance from which the virtual computing instance has been cloned.

3. The method of claim 2, further comprising:
receiving a notification of a policy change; and
in response to receiving the notification, retrieving an updated security policy and applying the updated security policy to the virtual computing instance.

4. The method of claim 3, wherein the policy change triggers the notifications and the policy change is made by the cloud platform in response to newly discovered security vulnerabilities.

5. The method of claim 2, wherein the virtual computing instance and other virtual computing instances of the virtual infrastructure are cloned from the root virtual computing instance in response to an auto-scaling event in the virtual infrastructure.

6. The method of claim 1, wherein the virtual computing instance has a security agent, which communicates with the cloud platform, installed therein.

7. The method of claim 1, wherein the virtual computing instance is a virtual machine.

8. A non-transitory computer readable medium comprising instructions that are executable in a processor of a virtual computing instance to carry out a method of applying a security policy to the virtual computing instance, said method comprising:
determining that a universally unique identifier (UUID) of the virtual computing instance does not match an identifier stored in a configuration file of the virtual computing instance;
transmitting a request to register the virtual computing instance with a cloud platform for managing security policies of a virtual infrastructure that includes the virtual computing instance, the request including the UUID of the virtual computing instance and the identifier stored in the configuration file of the virtual computing instance;
in response to the request, receiving an identifier of a security policy to be applied; and
retrieving the security policy and applying the security policy to the virtual computing instance.

9. The non-transitory computer readable medium of claim 8, wherein the identifier stored in a configuration file of the virtual computing instance is a UUID of a root virtual computing instance from which the virtual computing instance has been cloned.

10. The non-transitory computer readable medium of claim 9, wherein the method further comprises:
receiving a notification of a policy change; and
in response to receiving the notification, retrieving an updated security policy and applying the updated security policy to the virtual computing instance.

11. The non-transitory computer readable medium of claim 9, wherein the policy change triggers the notifications and the policy change is made by the cloud platform in response to newly discovered security vulnerabilities.

12. The non-transitory computer readable medium of claim 9, wherein the virtual computing instance and other virtual computing instances of the virtual infrastructure are cloned from the root virtual computing instance in response to an auto-scaling event in the virtual infrastructure.

13. The non-transitory computer readable medium of claim 8, wherein the virtual computing instance has a security agent, which communicates with the cloud platform, installed therein.

14. The non-transitory computer readable medium of claim 8, wherein the virtual computing instance is a virtual machine.

15. A computer system comprising a plurality of host computers in which virtual computing instances are deployed, the virtual computing instances including a first virtual computing instance and a second virtual computing instance that is cloned from the first virtual computing instance, wherein the second virtual computing instance is programmed to carry out a method of applying a security policy thereto, said method comprising:
determining that a universally unique identifier (UUID) of the virtual computing instance does not match an identifier stored in a configuration file of the virtual computing instance;
transmitting a request to register the virtual computing instance with a cloud platform for managing security policies of a virtual infrastructure that includes the virtual computing instance, the request including the UUID of the virtual computing instance and the identifier stored in the configuration file of the virtual computing instance;
in response to the request, receiving an identifier of a security policy to be applied; and
retrieving the security policy and applying the security policy to the virtual computing instance.

16. The computer system of claim 15, wherein the identifier stored in a configuration file of the virtual computing instance is a UUID of a root virtual computing instance from which the virtual computing instance has been cloned.

17. The computer system of claim 16, wherein the method further comprises:
receiving a notification of a policy change; and
in response to receiving the notification, retrieving an updated security policy and applying the updated security policy to the virtual computing instance.

18. The computer system of claim 17, wherein the policy change triggers the notifications and the policy change is made by the cloud platform in response to newly discovered security vulnerabilities.

19. The computer system of claim 16, wherein the virtual computing instance and other virtual computing instances of the virtual infrastructure are cloned from the root virtual computing instance in response to an auto-scaling event in the virtual infrastructure.

20. The computer system of claim 15, wherein the virtual computing instance has a security agent, which communicates with the cloud platform, installed therein.
